(19) United States
(12) Patent Application Publication
(10) Pub. No.: US 2015/0053372 A1
(43) Pub. Date: Feb. 26, 2015

(54) PLATE HEAT TRANSMITTER

(71) Applicant: Mahle Behr GmbH & Co. KG, Stuttgart (DE)

(72) Inventors: Matthias Seitz, Stuttgart (DE); Christian Proksch, Stuttgart (DE); Daniel Hendrix, Fellbach (DE)

(21) Appl. No.: 14/464,352

(22) Filed: Aug. 20, 2014

(30) Foreign Application Priority Data
Aug. 21, 2013 (DE) 102013216523.4

(51) Int. Cl. H01M 10/613; F28F 3/12

(52) U.S. Cl. CPC H01M 10/5004; F28F 3/12
USPC 165/41; 165/168

(57) ABSTRACT

A plate heat transmitter may include a plate for transmitting thermal energy to a heat carrier. The heat transmitter may include a flow duct, delimited at least on one side by the plate, for channeling a flow of the heat carrier along the plate in a predetermined flow direction. A plurality of nubs may be included projecting from the plate into the flow duct, for distributing the heat carrier within the flow duct. At least two adjacent nubs may be connected with at least one of (i) one another and (ii) a duct delimitation to form a flow barrier running substantially transversely to the flow direction, to block the flow of heat carrier in the flow direction.

### CROSS-REFERENCE TO RELATED APPLICATIONS

This application claims priority to German Patent Application No. 10 2013 216 523.4 filed Aug. 21, 2013, the contents of which are hereby incorporated by reference in their entirety.

### TECHNICAL FIELD

The invention relates to a plate heat transmitter according to the introductory clause of claim 1. The invention further relates to an electric motor vehicle with such a plate heat transmitter according to the introductory clause of claim 11.

### BACKGROUND

According to current understanding, an electric motor vehicle, electric car (E-car) or electromobile (E-mobile) is a motor vehicle which is driven at least partially by an electric motor and which can obtain the electrical energy necessary for its locomotion from an internal energy store. This energy store is a critical aspect of the development of generic electric motor vehicles, because electric motor vehicles as automobiles—unlike for instance rail vehicles—can not remain connected to a stationary power network during travel. Electric vehicles can only achieve ranges which are equal to those of motor vehicles driven by combustion engines through efficient energy stores with high energy density. According to the prior art, ranges of up to 250 km and more can be realized in this way.

In the present context, the concept of the “electric vehicle” includes here explicitly hybrid electric motor vehicles, which are also designated as hybrid electric vehicles (HEVs), hybrid vehicles or hybrid cars. This comprises motor vehicles which are driven by at least one electric motor and a further energy converter and which can obtain the energy required for their operation from an operating fuel tank in addition to the mentioned electrical energy store.

The high energy density and efficiency of the energy stores used in electric motor vehicles frequently causes them to be heated considerably in operation, so that generic electric motor vehicles are typically equipped with a suitable air- or liquid cooling.

DE 199 61 826 A 1 therefore proposes, for use in the automobile industry, a vaporiser which has first connecting regions or points with an identical form and with a random or respectively irregular arrangement, wherein adjacent to at least one fluid inlet, second connecting regions are provided, having a larger section than the first connecting regions. A plate of the vaporiser comprises here at its ends openings for supply with refrigerant fluid, and ducts, in order to enable the flow of the fluid from one end to another of the plates. The plots or respectively connecting regions of elongated and substantially identical shape are distributed in such a manner that their arrangements are random or respectively arbitrary or respectively irregular. The connecting regions have a section which is contained, for example, between 5 mm² and 15 mm², in particular preferably of equal to 6 mm². Adjacent to the openings, i.e. in a flow direction change region, connecting regions are arranged, e.g. in a quantity of two, with larger dimensions than the connecting regions and namely for example contained between 20 mm² and 35 mm², in particular preferably of equal to 21 mm².

EP 1 308 687 A1 discloses the flow duct in a panel of a heat exchanger which is flowed through by a fluid and which is intended to promote the heat exchange between an external environment and the fluid, which is formed by at least two plates which are connected with one another, in order to define a circulation duct, the cross-section of which is a cross-section for passage of the fluid, wherein the circulation duct has an inlet opening for the fluid and an outlet opening for the fluid, wherein the tube has a means for the partial closure of the circulation duct, which is intended to keep the passage cross-section of the duct substantially constant between the inlet opening and the outlet opening.

Finally, DE 41 42 177 A 1 proposes providing a plate heat exchanger with ducts which are flowed through in co-current flow or counter-current flow, which are formed on the one hand by individual plates connected to form plate pairs, and on the other hand by the plate pairs which are joined together to form a plate stack. In order to distribute the media entering through the inflow cross-sections within a short axial entry region onto the full duct width, the individual plates are provided with vane-like elevations, which project at least from one side into the respective flow duct. To improve the heat exchange efficiency, the individual plates can be provided with profiles adjoining the entry region, running over the entire duct width and duct length, preferably of a plurality of individual nubs, in order to generate turbulences in the ducts.

The uniform distribution of the coolant within the plates proves to be a problem in such plate heat transmitters. In this respect, the formation of only poorly flowed-through problem regions can occur, for example in the corners of the plates, which considerably impair the homogeneity with regard to temperature of the entire heat transmitter. A reduction of the duct width presents itself as insufficient to solve this problem, because it can mostly only be realized at the price of a decrease in pressure caused by the meandering shape of the ducts. An optimum design of the inflow- and outflow regions of a plate heat transmitter with wide flow ducts, however, requires extensive calculations with regard to fluid mechanics, which in view of their complexity increase the expenditure in terms of time and costs for the development.

### SUMMARY

The invention is therefore based on the problem of providing a plate heat transmitter with a standardised nub field, which is distinguished by a more uniform distribution of the coolant and accordingly homogeneous temperature distribution.

These problems are solved by a plate heat transmitter having the features of claim 1 and an electric motor vehicle having the features of claim 11.

The invention is accordingly based on the basic idea of connecting with one another in a targeted manner individual nubs projecting into the flow duct for the more uniform distribution of the heat carrier in the flow duct of a plate heat transmitter. In practice, respectively two nubs lying adjacent to one another in the flow direction are united in the function of a flow barrier oriented transversely to the flow direction, so that they block the flow direction in this partial region of the flow duct and compel the heat carrier to a lateral detour. “Transverse” means, in this sense, not exclusively orthogonal to the flow direction.

A particular advantage of this approach lies in its universal applicability for optimising flow in the most varied of duct geometry. Thus, the invention can be used on the one hand to improve generic plate heat exchangers with a U-shaped flow duct, as discussed by the already acknowledged DE 199 61 826 A 1 and EP 1 308 687 A 1. On the other hand, plate heat exchangers such as that of DE 41 42 177 A 1, which are based on an I- or Z-shaped flow duct with a central connecting piece, can also be subjected to an optimisation of their nub geometry in a manner according to the invention.

The homogenisation of the flow achieved by means of an embodiment of the invention may in these cases begin not only in the main flow region of the plate heat transmitter—for instance serving for cooling—, but already in its connecting piece region situated upstream. Thus, the eccentric position of the connecting piece, for instance in plate heat transmitters of the U-type, can be accommodated appropriately by an internal nub of the connecting piece region adjacent to the cooling region being connected with a duct delimitation, running around the plate, to block the flow direction. In the case of a central position of the connecting piece, as characterizes for example devices of the I-type, however, two central nubs of the connecting piece region, adjacent to the cooling region, can serve as start- and end points of a corresponding flow barrier.

Further important features and advantages of the invention will emerge from the subclaims, from the drawings and from the associated description of figures with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained in further detail in the following description, wherein the same reference numbers refer to identical or similar or functionally identical components.

### BRIEF DESCRIPTION OF THE DRAWINGS

There are shown, respectively diagrammatically

FIG. 1 the partial top view of a plate heat exchanger with eccentric connecting piece according to a first embodiment of the invention,

FIG. 2 a more detailed top view of a plate heat exchanger with eccentric connecting piece according to a second embodiment of the invention,

FIG. 3 a top view, corresponding to FIG. 2, of a plate heat exchanger with central connecting piece according to a third embodiment of the invention,

FIG. 4 a more comprehensive top view of the plate heat exchanger with eccentric connecting piece according to the second embodiment of the invention,

FIG. 5 a top view, corresponding to FIG. 4, of the plate heat exchanger with central connecting piece according to the third embodiment of the invention and

FIG. 6 a top view, corresponding to FIGS. 4 and 5, of a plate heat exchanger with central connecting piece according to a fourth embodiment of the invention.

### DETAILED DESCRIPTION

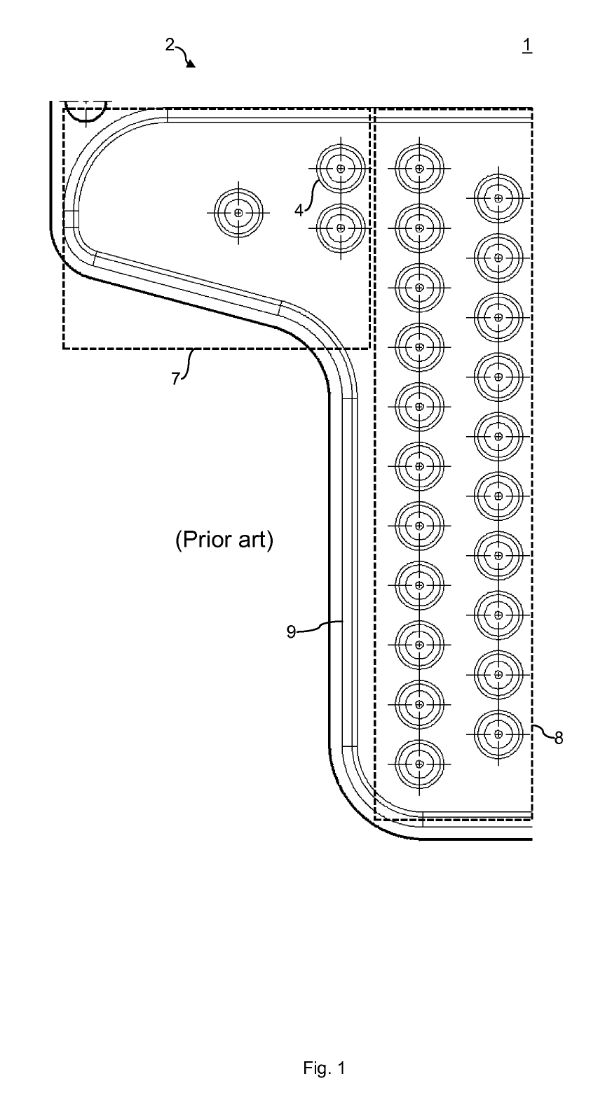

The top view of FIG. 1 illustrates a plate heat exchanger 1, the flow barriers of which, which are essential to the invention, are arranged outside the cutout which is shown. In this respect, FIG. 1 serves solely to explain the basic geometry of a plate heat exchanger 1 forming the basis of the approach of the invention, the directing of flow of which corresponds here to the usual structural form of the U-type. Comparable plate heat transmitters (PHT) are also designated in thermal engineering, depending on application, as plate heat exchangers (PHE) or as plate coolers (PC), but generally share the same operating principle.

As FIG. 1 shows, a plate 2 of the plate heat transmitter 1 comprises a plurality of regularly distributed nubs 4, of which, for reasons of clarity, only one nub 4 is given a reference number. The whole of the nubs 4 are distributed on a connecting piece region 7—serving for connecting the plate heat transmitter 1 to a corresponding coolant- or refrigerant circuit—, and on a cooling region 8, adjoining thereto, of the plate 2, wherein a distinct majority of the nubs 4 is arranged in the latter region 8. The nubs 4 of the embodiment which is shown, constructed as convex bulges of the plate 2, have here—nothwithstanding the possibility of alternative, for instance oval or drop-shaped embodiments—the spatial geometric shape of spherical caps of a height which stands substantially perpendicularly to the base plane of the plate 2 and therefore the plane of view of FIG. 1 coplanar therewith.

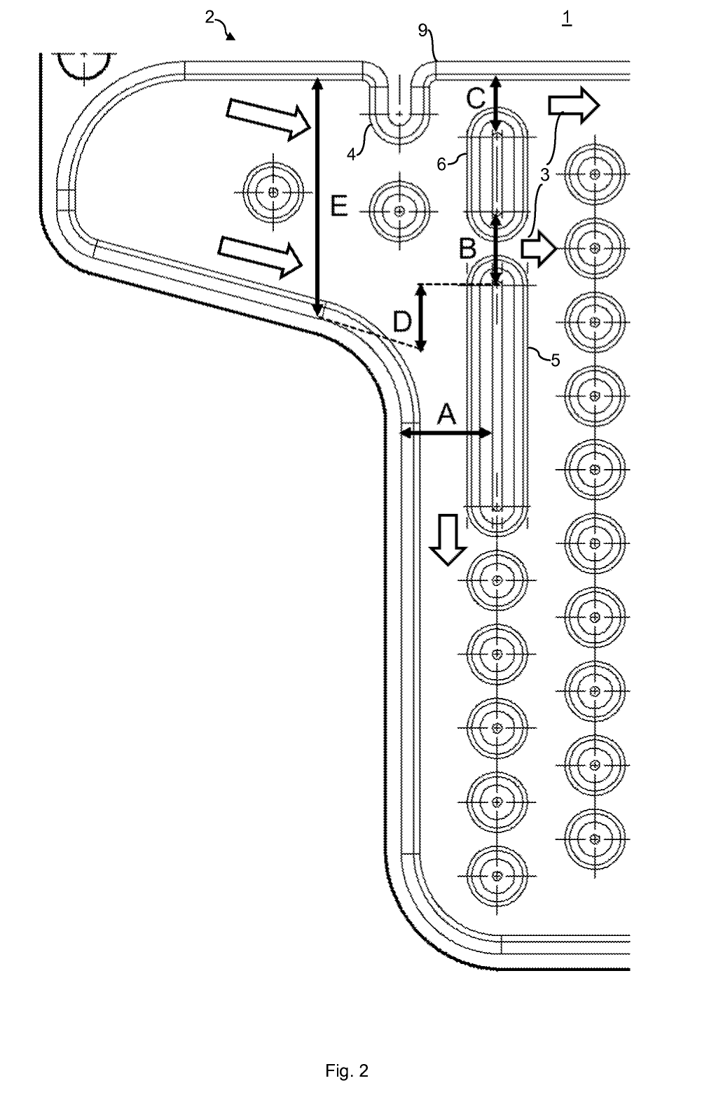

Owing to their shape and orientation, the hubs 4 project with a considerable portion of their height into the flow duct of the plate heat transmitter 1—which duct is formed in a planar manner through the plate 2 and laterally through a duct delimitation 9 running around the latter—, and cause through their specific profile a turbulent flow which is promoted to a considerable extent by the quasi matrix-like arrangement of the nubs 4 which is shown. As a second embodiment of a plate heat transmitter 1 shown in FIG. 2 also demonstrates, the nubs 4 are arranged in the cooling region in a plurality of rows—running transversely to the flow direction 3 of the heat carrier along the plate 2—such that respectively two rows of nubs 4 following one another have approximately the same spacing. Also within a row, the nubs 4 are distributed substantially equidistantly in a predetermined nub spacing B over the width of the flow duct. Schematically, the rows of the grid structure formed by the nubs 4 alternate here in pairs in such a way that respectively two rows arranged one behind the other in the flow direction 3 are offset to one another by half the said nub spacing B. In an alternative embodiment, not shown in FIG. 2, a variant offsetting of the nub rows may be selected instead, without departing from the scope of the invention.

The width E of the internal connecting piece region in the embodiment of FIG. 2 forms here a base measurement forming the basis of the flow barrier according to the invention. Thus already in the connecting piece region itself a nub 4, arranged lying internally at its transition to the cooling region, is connected with the duct delimitation 9 over a length which is between 5 percent and 50 percent of the connecting piece region width E. Also in the cooling region, a first flow barrier 5 projects by a distance D into the main flow of the connecting piece region, which conforms to the mathematical equation 0<D<0.75·E. The overall length of the first flow barrier 5 is oriented, meanwhile, to the geometry of the cooling region and corresponds in practice to between 5 percent and 60 percent of its width. The flow barriers can also (additionally) be positioned in the second or third nub row transversely to the flow direction.

A second flow barrier 6 is arranged centrally in the resulting inner flow duct of the cooling region and from the duct delimitation 9 at a predetermined lateral delimitation distance C transversely to the flow direction 3. The grid formed by the nubs 4 has, in addition, an orthogonal delimitation distance A longitudinally to the flow direction 3, for which the relationship 0.5·(B+C)<A<2·(B+C) applies. Corresponding flow barriers may also be provided in a deflection region of the plate 2, not shown in FIG. 2.

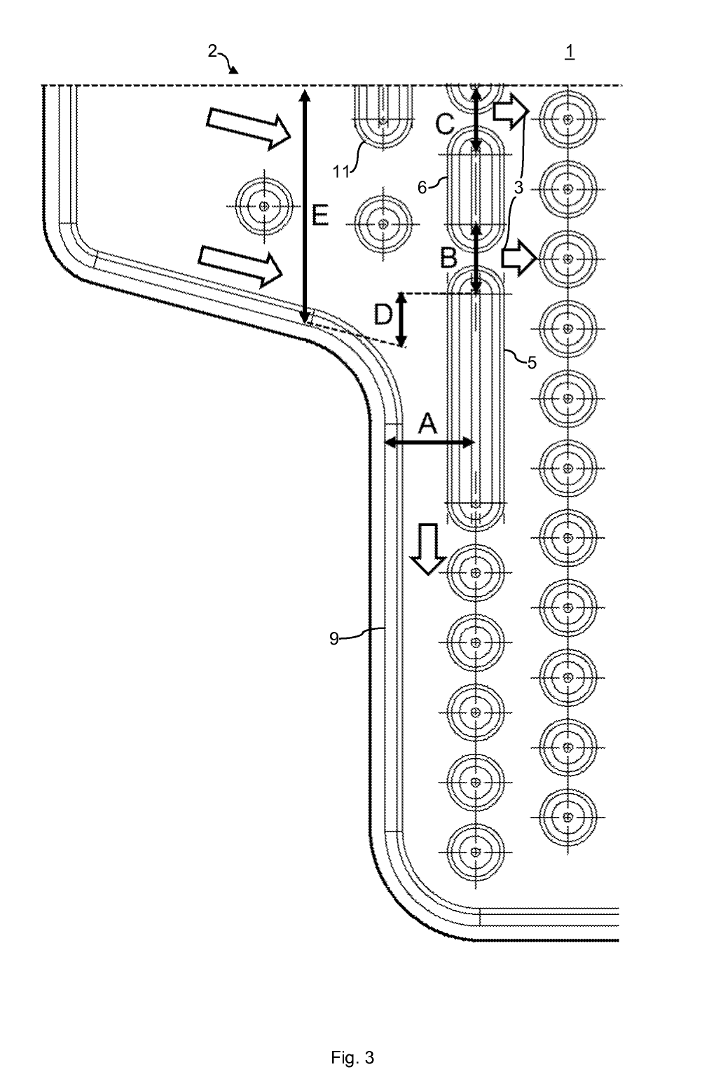

FIG. 3 illustrates a third embodiment of the plate heat transmitter 1 according to the invention, which differs from that of FIG. 2 by the central position of the connecting piece region of its plate 2, as is used for instance in an I-shaped flow. In this shape variant, in place of the connection of an internal nub with the duct delimitation 9, is that of the nubs 4 arranged centrally at the transition between the connecting piece- and cooling region, so that the integrally embodied nub 11 blocks the flow direction 3 over a width between 5 percent and 50 percent of the connecting piece region width E.

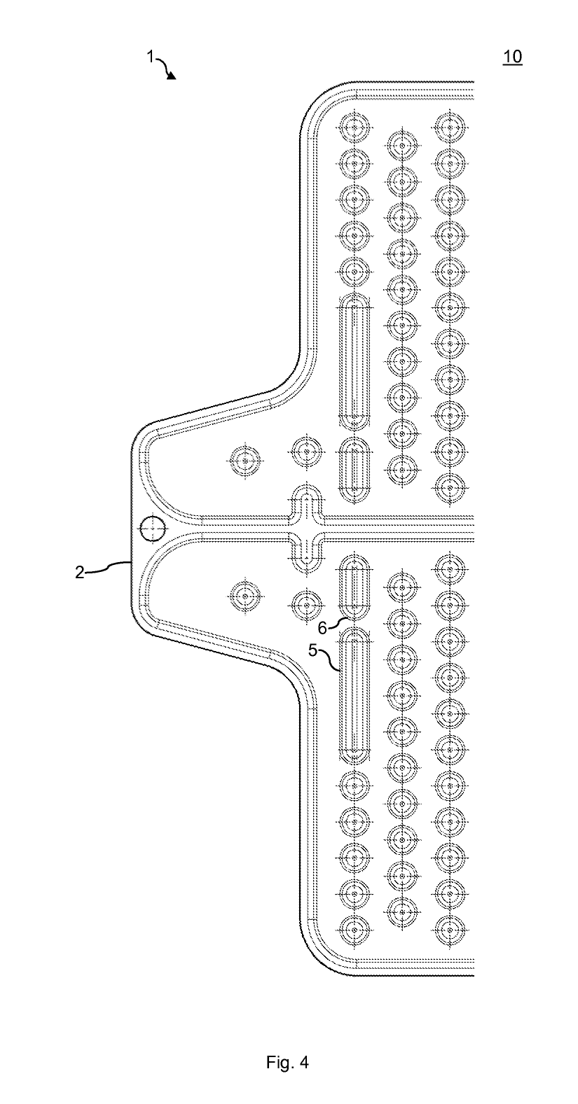

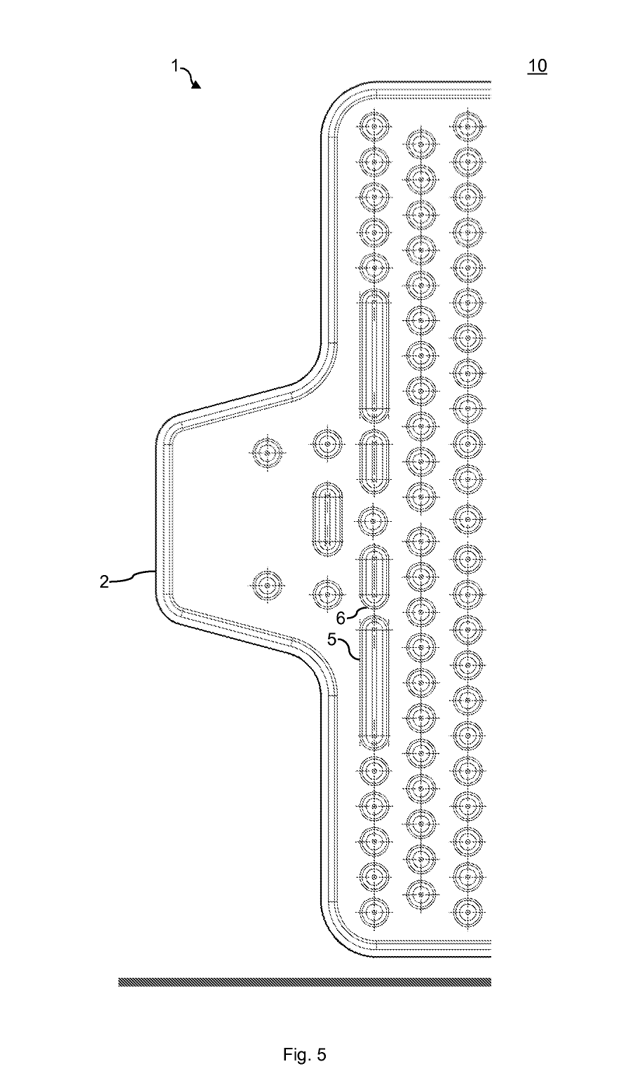

As FIGS. 4 and 5 show with the aid of a more comprehensive overview illustration of the second and third embodiments of the plate heat transmitter 1 according to the invention, further flow barriers corresponding to the first flow barrier 5 and the second flow barrier 6 in axially symmetrical arrangement are also provided in an outflow region of the respective plate 2.

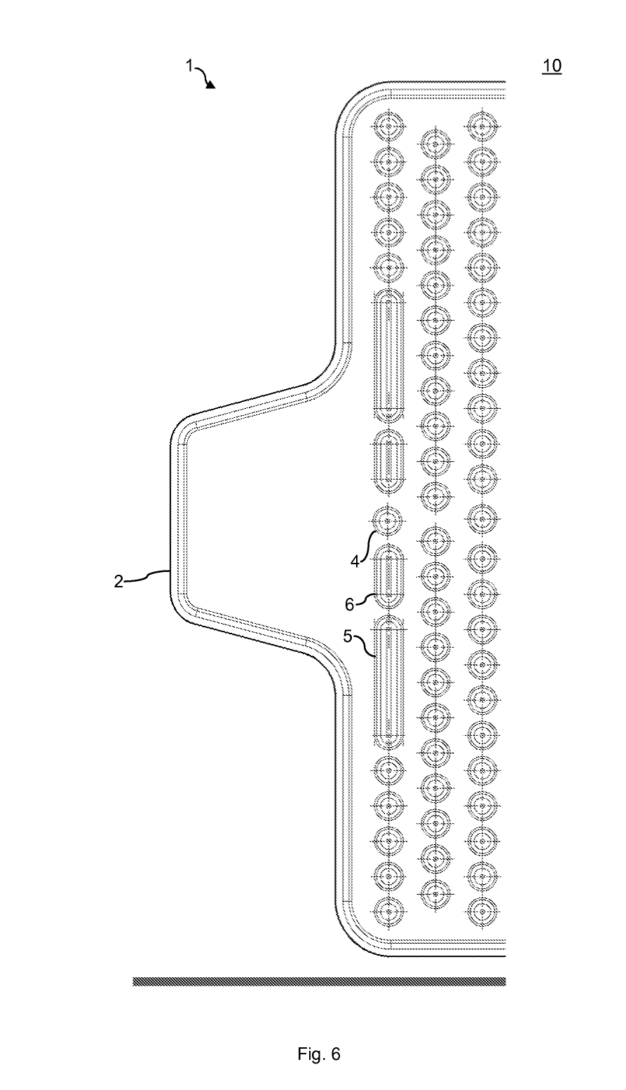

FIG. 6, finally, illustrates that in an alternative, fourth embodiment of a plate heat exchanger 1 according to the invention, the connecting piece region may also be embodied entirely free of nubs. Irrespective of this factor, in the present configuration the cooling region, covered with nubs 4, also comprises the first flow barrier 5, the second flow barrier 6 and its respectively axially-symmetrically arranged counterparts according to an analogous scheme.

As FIGS. 4, 5 and 6 likewise indicate, the respective plate heat transmitter 1 can be used advantageously within a generic electric motor vehicle 10, in order to convey away the heat which has been released during the energy conversion by means of a coolant or refrigerant flowing through the plate heat transmitter 1—arranged for battery cooling preferably in the immediate vicinity of the energy store—, and therefore to prevent an overheating of the electric motor vehicle 10.

1. A plate heat transmitter, comprising:
a plate for transmitting thermal energy to a heat carrier,
a flow duct, delimited at least on one side by the plate, for channeling a flow of the heat carrier along the plate in a predetermined flow direction, and
a plurality of nubs, projecting from the plate into the flow duct, for distributing the heat carrier within the flow duct,
wherein at least two adjacent nubs are connected with at least one of (i) one another and (ii) a duct delimitation to form a flow barrier, running substantially transversely to the flow direction, to block the flow of the heat carrier in the flow direction.

2. The plate heat transmitter according to claim 1, wherein the plate includes:
a connecting piece region with a predetermined connecting piece region width,
a cooling region, adjoining the connecting piece region, with a predetermined cooling region width, and
a main flow region arranged according to the flow direction in rectilinear extension of the connecting piece region in the cooling region.

3. The plate heat transmitter according to claim 2, wherein the nubs are arranged in the cooling region in a plurality of rows running substantially transversely to the flow direction defining a predetermined row spacing between two respective rows following one another in the flow direction.

4. The plate heat transmitter according to claim 3, wherein the nubs are arranged in the cooling region in a grid formed by the rows so that within a row respectively two adjacent nubs have a predetermined nub spacing.

5. The plate heat transmitter according to claim 4, wherein the two rows following one another are offset to one another by a half of the nub spacing.

6. The plate heat transmitter according to claim 4, wherein the duct delimitation, at least partially runs around the plate, for delimiting the flow duct, and the grid longitudinally to the flow direction has an orthogonal delimitation distance and transversely to the flow direction has a lateral delimitation distance to the duct delimitation.

7. The plate heat transmitter according to claim 6, wherein the connecting piece region lies eccentrically and an internal nub, adjacent to the cooling region, is connected in the eccentric connecting piece region with the duct delimitation over a length of at least 5 percent and at most 50 percent of the connecting piece region width.

8. The plate heat transmitter according to claim 2, wherein the connecting piece region lies centrally, and two central nubs, adjacent to the cooling region, are connected with one another in the central connecting piece region over a length of at least 5 percent and at most 50 percent of the connecting piece region width.

9. The plate heat transmitter according to claim 2, wherein a first flow barrier extends in the cooling region over at least 5 percent and at most 60 percent of the cooling region width and projects into the main flow region by a distance, which is less than 75 percent of the connecting piece region width.

10. The plate heat transmitter according to claim 6, further comprising a second flow barrier arranged in the main flow region so that the orthogonal delimitation distance is at least 50 percent and at most 200 percent of a sum of the nub spacing and of the lateral delimitation distance.

11. An electric motor vehicle, comprising:
an electrical energy store for the storage of electrical energy,
an electric motor for converting the electrical energy into kinetic energy with the emission of heat,
a heat carrier for conveying away thermal energy, and
a plate heat transmitter, adjacent to the energy store and flowed through by the heat carrier, for cooling the energy store, the plate heat transmitter including:
a plate for transmitting thermal energy to the heat carrier,
a flow duct delimited at least on one side by the plate for channeling a flow of the heat carrier along the plate in a predetermined flow direction, wherein the plate includes a duct delimitation at least partially extending around the plate for delimiting the flow duct,
a plurality of nubs projecting from the plate into the flow duct for distributing the heat carrier within the flow duct, wherein at least two adjacent nubs are connected with at least one of (i) one another and (ii) the duct delimitation to form a flow barrier running substantially transversely to the flow direction to block the flow of the heat carrier in the flow direction.

12. The electric motor according to claim 11, wherein the plate includes:
a connecting piece region with a predetermined connecting piece region width;
a cooling region adjoining the connecting piece region having a predetermined cooling region width; and
a main flow region arranged in rectilinear extension of the connecting piece region in the cooling region relative to the flow direction.

13. The electric motor according to claim 12, wherein the nubs are arranged in the cooling region in a plurality of rows running transversely to the flow direction defining a predetermined row spacing between two respective rows following one another in the flow direction.

14. The electric motor according to claim 13, wherein the nubs are arranged in the cooling region in a grid formed by the plurality of rows such that within a row respectively two adjacent nubs have a predetermined nub spacing.

15. The electric motor according to claim 14, wherein two adjacent rows are offset to one another by a half of the nub spacing.

16. The electric motor according to claim 14, where the grid longitudinally to the flow direction includes an orthogonal delimitation distance and transversely to the flow direction includes a lateral delimitation distance to the duct delimitation.

17. The electric motor according to claim 16, wherein the connecting piece region lies eccentrically and an internal hub adjacent to the cooling region connects to the eccentric connecting piece region with the duct delimitation over a length of 5 to 50 percent of the connecting piece region width.

18. The electric motor according to claim 16, wherein the connecting piece region lies centrally and two central nubs adjacent to the cooling region connect with one another in the central connecting piece region over a length of 5 to 50 percent of the connecting piece region width.

19. The plate heat transmitter according to claim 1, wherein the heat carrier includes at least one of a coolant and a refrigerant.

20. A plate heat transmitter, comprising:
a plate for transmitting thermal energy to a heat carrier, the plate including a connecting piece region with a predetermined connecting piece region width, a cooling region adjoining the connecting piece region having a predetermined cooling region width, and a main flow region arranged in rectilinear extension of the connecting piece region relative to the flow direction in the cooling region;
a flow duct delimited at least on one side by the plate for channeling a flow of the heat carrier along the plate in a predetermined flow direction, wherein the plate includes a duct delimitation at least partially extending around the plate for delimiting the flow duct;
a plurality of nubs projecting from the plate into the flow duct for distributing the heat carrier within the flow duct, the plurality of nubs arranged in a plurality of rows in the cooling region running transversely to the flow direction to define a predetermined row spacing between two respective adjacent rows in the flow direction;
wherein at least two adjacent nubs connect with at least one of (i) one another and (ii) the duct delimitation to form a flow barrier running substantially transversely to the flow direction to block the flow of the heat carrier in the flow direction.
